(19) United States
(12) Patent Application Publication
(10) Pub. No.: US 2025/0316674 A1
(43) Pub. Date: Oct. 9, 2025

(54) MULTILAYER ELECTRODE MANUFACTURING APPARATUS AND MULTILAYER ELECTRODE MANUFACTURING METHOD USING THE SAME

(71) Applicant: Samsung SDI Co., Ltd., Yongin-si (KR)

(72) Inventor: Hyunjin LEE, Yongin-si (KR)

(21) Appl. No.: 18/828,951

(22) Filed: Sep. 9, 2024

(30) Foreign Application Priority Data
Apr. 5, 2024 (KR) 10-2024-0046766

(51) Int. Cl. H01M 4/04; H01M 4/62

(52) U.S. Cl. CPC H01M 4/0435; H01M 4/622

(57) ABSTRACT

A multilayer electrode manufacturing apparatus includes: an electrode substrate supply roll configured to unwind an electrode substrate; a first upper supply roll configured to unwind a first upper film, the first upper film including a first release film and a first active material layer on the first release film; a first pressurizing unit configured to pressurize together the electrode substrate, the first active material layer, and the first release film that are sequentially stacked; and a first upper recovery roll configured to recover the first release film by separating the first release film from the first active material layer.

### CROSS-REFERENCE TO RELATED APPLICATION

The present application claims priority to and the benefit of Korean Patent Application No. 10-2024-0046766, filed on Apr. 5, 2024, in the Korean Intellectual Property Office, the entire disclosure of which is incorporated herein by reference.

### BACKGROUND

### 1. Field

Aspects of embodiments of the present disclosure relate to a multilayer electrode manufacturing apparatus and a multilayer electrode manufacturing method using the same.

### 2. Description of the Related Art

Recently, with the rapid spread of battery-powered electronic devices, such as mobile phones, laptop computers, and electric vehicles, there is a rapidly increasing demand for rechargeable (or secondary) batteries exhibiting high energy density and high capacity. Therefore, intensive research has been conducted to improve the performance of rechargeable batteries, such as rechargeable lithium batteries.

A rechargeable lithium battery generally includes a positive electrode, a negative electrode, and an electrolyte. The positive and negative electrodes include an active material in which intercalation and deintercalation are possible and generate electrical energy by oxidation and reduction reactions when lithium ions are intercalated and deintercalated.

### SUMMARY

Embodiments of the present disclosure provide a multilayer electrode manufacturing apparatus and method using a roll-to-roll type continuous process to manufacture a multilayer electrode.

Embodiments of the present disclosure provide a multilayer electrode manufacturing apparatus and method capable of precisely adjusting a coating amount (or thickness) of each active material layer of a multilayer electrode.

Embodiments of the present disclosure provide a multilayer electrode manufacturing apparatus and method capable of increasing a bonding force between an electrode substrate and an active material layer.

According to an embodiment of the present disclosure, a multilayer electrode manufacturing apparatus includes: an electrode substrate supply roll configured to unwind an electrode substrate; a first upper supply roll configured to unwind a first upper film that includes a first release film and a first active material layer on the first release film; a first pressurizing unit configured to pressurize together the electrode substrate, the first active material layer, and the first release film that are sequentially stacked; and a first upper recovery roll configured to recover the first release film by separating the first release film from the first active material layer.

According to another embodiment of the present disclosure, a multilayer electrode manufacturing apparatus includes: an electrode substrate supply roll configured to unwind an electrode substrate; a first upper supply roll configured to unwind and provide a first upper film on a top surface of the electrode substrate, the first upper film including a first release film and a first active material layer on the first release film; a first lower supply roll configured to unwind and provide a first lower film on a bottom surface of the electrode substrate, the first lower film including a second release film and a second active material layer on the second release film; and a first pressurizing unit configured to pressurize together the second release film, the second active material layer, the electrode substrate, the first active material layer, and the first release film that are sequentially stacked.

According to another embodiment of the present disclosure, a multilayer electrode manufacturing method includes: providing a first upper film on a top surface of an electrode substrate as it travels in a first direction, the first upper film including a first release film and a first active material layer on the first release film; performing a first pressurization process to pressurize together the electrode substrate, the first active material layer, and the first release film that are sequentially stacked; selectively removing the first release film to form a first stack that includes the electrode substrate and the first active material layer; providing a second upper film on a top surface of the first stack, the second upper film including a second release film and a second active material layer on the second release film; and performing a second pressurization process to pressurize together the first stack, the second active material layer, and the second release film that are sequentially stacked.

### BRIEF DESCRIPTION OF DRAWINGS

FIG. 1 is a simplified conceptual diagram of a rechargeable lithium battery according to an embodiment of the present disclosure.

FIGS. 2 and 3 are cross-sectional views of a multilayer electrode according to embodiments of the present disclosure.

FIGS. 4 and 6 are schematic diagrams of a multilayer electrode manufacturing apparatus according to embodiments of the present disclosure.

FIGS. 5A and 5B are cross-sectional views of an adhesion layer forming unit of a multilayer electrode manufacturing apparatus according to embodiments of the present disclosure.

FIGS. 7 to 12 are cross-sectional views of steps of a multilayer electrode manufacturing method according to an embodiment of the present disclosure.

### DETAILED DESCRIPTION

To sufficiently understand aspects and features of the present disclosure, some embodiments of the present disclosure will be described with reference to the accompanying drawings. It should be noted, however, that the present disclosure is not limited to the following embodiments and may be implemented in various forms. Rather, some embodiments are provided below to describe aspects and features of the present disclosure and to inform those skilled in the art as to the full the scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

As used herein, the term “combination thereof” may refer to a mixture, a stack, a composite, a copolymer, an alloy, a blend, or a reaction product.

In this description, the term “mixture density” may be obtained by dividing weight by volume of components (e.g., active material, binder, conductive material, and so forth) of an electrode excluding a current collector from the electrode.

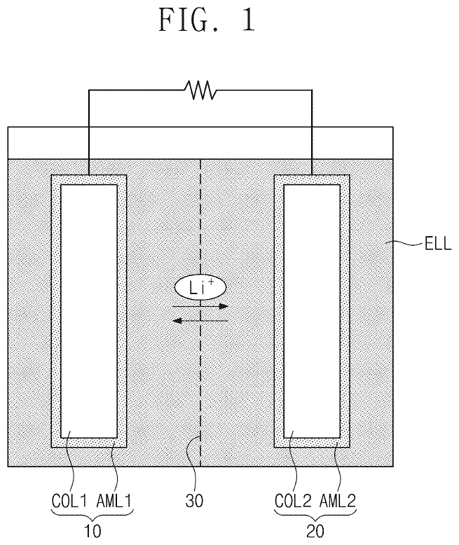

FIG. 1 is a simplified conceptual diagram of a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated by (or impregnated in) the electrolyte ELL.

The electrolyte ELL may be a medium by which lithium ions are transferred between (e.g., move between) the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material.

For example, the positive electrode 10 may include an additive that can act as a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may improve attachment of positive electrode active material particles to each other and may improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinyl chloride, polyvinyl fluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material without causing chemical change of a battery may be used as the conductive material to constitute the battery. The conductive material may include, for example, a carbon-based material, such as natural graphite, artificial graphite, carbon black, acetylene black, Ketjenblack® (a registered trademark of Akzo Nobel Chemicals B.V.), carbon fiber, carbon nano-fiber, and carbon nano-tube; a metal powder or metal fiber containing one or more of copper, nickel, aluminum, and silver; a conductive polymer, such as a polyphenylene derivative; or a mixture thereof.

The current collector COL1 may include aluminum (Al), but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol %, and equal to or less than about 99 mol % relative to 100 mol % of metal devoid of lithium in the lithium transition metal composite oxide. The high nickel-based positive electrode active material may achieve high capacity and, thus, may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may improve attachment of negative electrode active material particles to each other and may improve attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylic rubber, butyl rubber, fluoroelastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may be included. The cellulose-based compound may include one or more of carboxymethyl cellulose, hydroxypropyl methylcellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material without causing chemical change of a battery may be used as the conductive material to constitute the battery. For example, the conductive material may include a carbon-based material, such as natural graphite, artificial graphite, carbon black, acetylene black, Ketjenblack®, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite, such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Gₑ, Al, and Sn.

The material that can dope and de-dope lithium may include a Si-based negative electrode active material or a Sn-based negative electrode active material. The Si-based negative electrode active material may include silicon, silicon-carbon composite, SiOₓ (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, a Sn-based alloy, a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type of the rechargeable lithium battery, the separator 30 may be present between positive electrode 10 and the negative electrode 20. The separator 30 may include one or more of polyethylene, polypropylene, and polyvinylidene fluoride and may be a multi-layered separator, such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, or a combination thereof.

The porous substrate may be a polymer layer including one selected from polyolefin, such as polyethylene and polypropylene, polyester, such as polyethylene terephthalate and polybutylene terephthalate, polyacetal, polyamide, polyimide, polycarbonate, polyetherketone, polyaryletherketone, polyetherimide, polyamide-imide, polybenzimidazole, polyethersulfone, polyphenylene oxide, cyclic olefin copolymer, polyphenylene sulphide, polyethylene naphthalate, glass fiber, Teflon® (a registered trademark of The Chemours Company FC, LLC), and polytetrafluoroethylene, or may be a copolymer or mixture including two or more of the materials mentioned above.

The organic material may include a polyvinylidene fluoride-based copolymer or a (meth)acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed in one coating layer or may be present as a stack including a coating layer including the organic material and a coating layer including an inorganic material.

### Electrolyte ELL

The electrolyte ELL for the rechargeable lithium battery may include a non-aqueous organic solvent and a lithium salt.

The non-aqueous organic solvent may act as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles, such as R—CN (where R is a hydrocarbon group having a C2 to C20 linear, branched, or cyclic structure and may include a double bond, an aromatic ring, or an ether group); amides, such as dimethylformamide; dioxolanes such as 1,3-dioxolane or 1.4-dioxolane; or sulfolanes.

The non-aqueous organic solvent may be used alone or in a mixture of two or more substances.

In addition, when a carbonate-based solvent is used, a cyclic carbonate and a chain carbonate may be mixed and used, and the cyclic carbonate and the chain carbonate may be mixed in a volume ratio in a range of about 1:1 to about 1:9.

The lithium salt may be a material that is dissolved in the non-aqueous organic solvent to act as a supply source of lithium ions in a battery and plays a role in enabling the basic operation of a rechargeable lithium battery and in promoting the movement of lithium ions between positive and negative electrodes. The lithium salt may include, for example, at least one selected from LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato)borate (LiBOB)

The following describes a multilayer electrode manufactured by using a multilayer electrode manufacturing apparatus according to some embodiments of the present disclosure. Differences between the previously described electrode (the positive electrode 10 and/or the negative electrode 20) will be discussed in detail below.

### Multilayer Electrode MLE

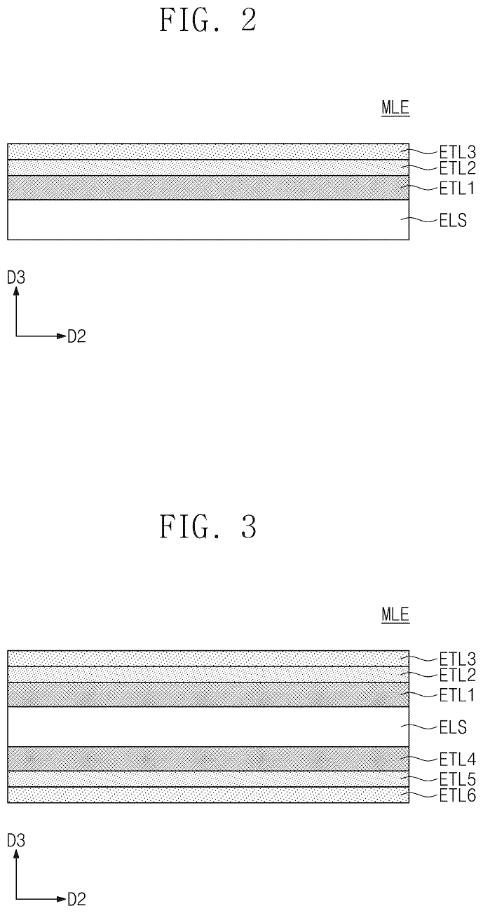

FIGS. 2 and 3 are cross-sectional views of a multilayer electrode according to embodiments of the present disclosure.

Referring to FIG. 2, a multilayer electrode MLE may include an electrode substrate ELS, a first active material layer ETL1 on a top surface of the electrode substrate ELS, and a second active material layer ETL2 on the first active material layer ETL1.

In an embodiment, the electrode substrate ELS may be the positive electrode current collector COL1 discussed above with reference to FIG. 1. In such an embodiment, each of the first and second active material layers ETL1 and ETL2 may be the positive electrode active material layer AML1 discussed above with reference to FIG. 1.

The first active material layer ETL1 may include a first positive electrode active material, a first binder, and a first conductive material. The second active material layer ETL2 may include a second positive electrode active material, a second binder, and a second conductive material.

In an embodiment, the first binder may be included in an amount in a range of about 50 wt % to about 95 wt % relative to the total weight of the first and second binders, and the second binder may be included in an amount in a range of about 5 wt % to about 50 wt % relative to the total weight of the first and second binders.

The multilayer electrode MLE may further include a third active material layer ETL3 on the second active material layer ETL2. The third active material layer ETL3 may be the positive electrode active material layer AML1 discussed above with reference to FIG. 1. The third active material layer ETL3 may include a third positive electrode active material, a third binder, and a third conductive material.

In an embodiment, the first binder may be included in an amount in a range of about 20 wt % to about 90 wt % relative to the total weight of the first to third binders, the second binder may be included in an amount in a range of about 5 wt % to about 40 wt % relative to the total weight of the first to third binders, and the third binder may be included in an amount in a range of about 5 wt % to about 40 wt % relative to the total weight of the first to third binders.

Each of the first to third binders may include at least one binder in the positive electrode active material layer AML1 discussed with reference to FIG. 1. Each of the first to third conductive materials may include at least one conductive material in the positive electrode active material layer AML1 discussed with reference to FIG. 1.

In an embodiment, the electrode substrate ELS may be the negative electrode current collector COL2 discussed above with reference to FIG. 1. In such an embodiment, each of the first and second active material layers ETL1 and ETL2 may be the negative electrode active material layer AML2 discussed above with reference to FIG. 1.

The first active material layer ETL1 may include a first negative electrode active material, a first binder, and a first conductive material. The second active material layer ETL2 may include a second negative electrode active material, a second binder, and a second conductive material.

In an embodiment, the first binder may be included in an amount in a range of about 50 wt % to about 95 wt % relative to the total weight of the first and second binders, and the second binder may be included in an amount in a range of about 5 wt % to about 50 wt % relative to the total weight of the first and second binders.

The multilayer electrode MLE may further include a third active material layer ETL3 on the second active material layer ETL2. The third active material layer ETL3 may be the negative electrode active material layer AML2 discussed above with reference to FIG. 1. The third active material layer ETL3 may include a third negative electrode active material, a third binder, and a third conductive material.

In an embodiment, the first binder may be included in an amount in a range of about 20 wt % to about 90 wt % relative to the total weight of the first to third binders, the second binder may be included in an amount in a range of about 5 wt % to about 40 wt % relative to the total weight of the first to third binders, and the third binder may be included in an amount in a range of about 5 wt % to about 40 wt % relative to the total weight of the first to third binders.

Each of the first to third binders may include at least one binder in the negative electrode active material layer AML2 discussed with reference to FIG. 1. Each of the first to third conductive materials may include at least one conductive material in the negative electrode active material layer AML2 discussed with reference to FIG. 1.

Referring to FIG. 3, the multilayer electrode MLE may include a fourth active material layer ETL4 on a bottom surface of the electrode substrate ELS and a fifth active material layer ETL5 on a bottom surface of the fourth active material layer ETL4 in addition to the active material layers ETL1 to ELT3 described above with respect to FIG. 2. The multilayer electrode MLE may further include a sixth active material layer ETL6 on a bottom surface of the fifth active material layer ETL5.

In an embodiment, each of the fourth to sixth active material layers ETL4 to ETL6 may be the positive electrode active material layer AML1 discussed above with reference to FIG. 1. In such an embodiment, the fourth active material layer ETL4 may include a fourth positive electrode active material, a fourth binder, and a fourth conductive material. The fifth active material layer ETL5 may include a fifth positive electrode active material, a fifth binder, and a fifth conductive material. The sixth active material layer ETL6 may include a sixth positive electrode active material, a sixth binder, and a sixth conductive material. Each of the fourth to sixth binders may include at least one binder in the positive electrode active material layer AML1 discussed with reference to FIG. 1. Each of the fourth to sixth conductive materials may include at least one conductive material in the positive electrode active material layer AML1 discussed with reference to FIG. 1.

In an embodiment, each of the fourth to sixth active material layers ETL4 to ETL6 may be the negative electrode active material layer AML2 discussed above with reference to FIG. 1. In such an embodiment, the fourth active material layer ETL4 may include a fourth negative electrode active material, a fourth binder, and a fourth conductive material. The fifth active material layer ETL5 may include a fifth negative electrode active material, a fifth binder, and a fifth conductive material. The sixth active material layer ETL6 may include a sixth negative electrode active material, a sixth binder, and a sixth conductive material. Each of the fourth to sixth binders may include at least one binder in the negative electrode active material layer AML2 discussed with reference to FIG. 1. Each of the fourth to sixth conductive materials may include at least one conductive material in the negative electrode active material layer AML2 discussed with reference to FIG. 1.

In an embodiment, the first binder may be included in an amount in a range of about 50 wt % to about 95 wt % relative to the total weight of the first and second binders, and the second binder may be included in an amount in a range of about 5 wt % to about 50 wt % relative to the total weight of the first and second binders. In an embodiment, the first binder may be included in an amount in a range

of about 20 wt % to about 90 wt % relative to the total weight of the first to third binders, the second binder may be included in an amount in a range of about 5 wt % to about 40 wt % relative to the total weight of the first to third binders, and the third binder may be included in an amount in a range of about 5 wt % to about 40 wt % relative to the total weight of the first to third binders.

The following will describe, in detail, a multilayer electrode manufacturing apparatus according to some embodiments of the present disclosure.

### Multilayer Electrode Manufacturing Apparatus

A multilayer electrode manufacturing apparatus according to some embodiments of the present disclosure may use a roll-to-roll method for producing a multilayer-structured electrode. The multilayer electrode manufacturing apparatus may be configured such that a substrate and a release film coated with an active material layer are rolled to transfer the active material layer onto the substrate, after which another release film coated with an active material layer is rolled against a top surface of the substrate (e.g., against a top surface of the previously deposited active material layer) to continuously manufacture a multilayer-structured electrode without the need for separate drying processes.

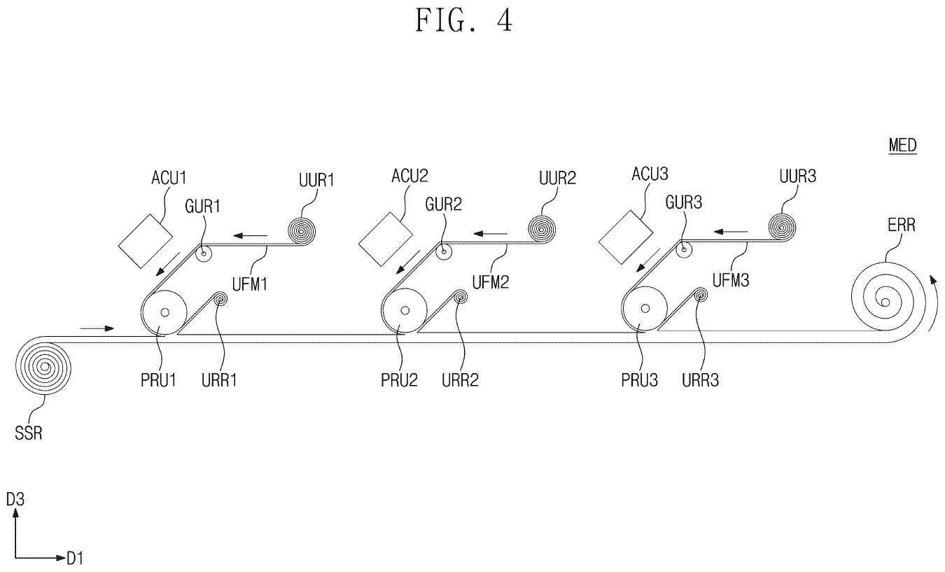

FIGS. 4 to 6 are schematic diagrams of a multilayer electrode manufacturing apparatus according to embodiments of the present disclosure.

Referring to FIG. 4, a multilayer electrode manufacturing apparatus MED may include an electrode substrate supply roll SSR, a first upper supply roll UUR1, a first adhesion layer forming unit ACU1, a first upper recovery roll URR1, a second upper supply roll UUR2, a second adhesion layer forming unit ACU2, a second upper recovery roll URR2, a first pressurizing unit PRU1, a second pressurizing unit PRU2, and an electrode recovery roll ERR. The multilayer electrode manufacturing apparatus MED may further include a third upper supply roll UUR3, a third adhesion layer forming unit ACU3, a third upper recovery roll URR3, and a third pressurizing unit PRU3. The multilayer electrode manufacturing apparatus MED may further include first, second, and third guide rollers GUR1, GUR2, and GUR3.

The electrode substrate supply roll SSR may be configured to unwind the electrode substrate ELS. In various embodiments, the electrode substrate ELS may be the positive electrode current collector COL1 or the negative electrode current collector COL2 discussed with reference to FIG. 1. For example, the electrode substrate ELS may include aluminum, copper, or stainless steel.

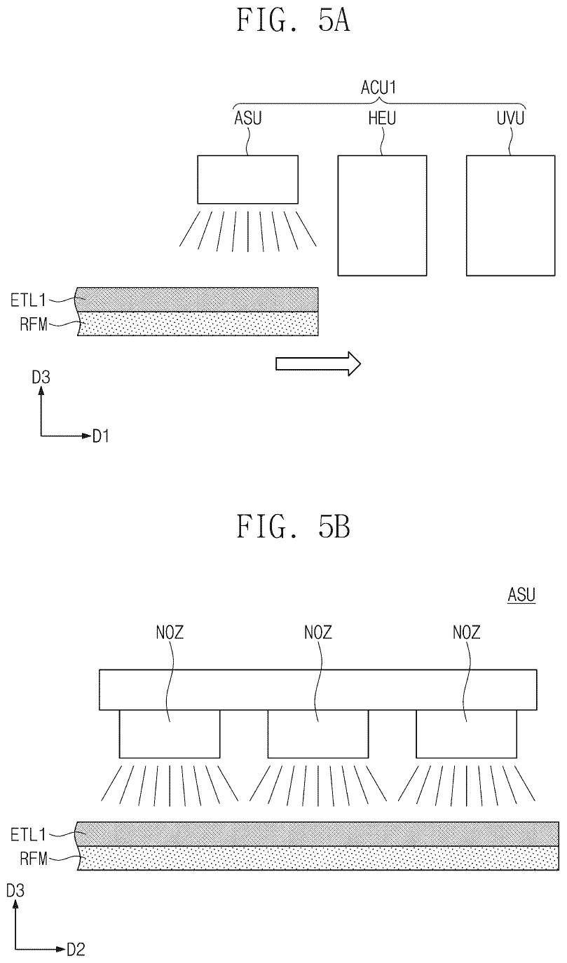

The first upper supply roll UUR1 may be configured to unwind a first upper film UFM1. The first upper film UFM1 may include a release film RFM and a first active material layer ETL1 on the release film RFM (see, e.g., FIGS. 5A and 5B).

The first adhesion layer forming unit ACU1 may be configured to coat an adhesive on the first active material layer ETL1 of the first upper film UFM1. Thus, an adhesion layer may be formed on the first active material layer ETL1.

FIGS. 5A and 5B are cross-sectional views of the first adhesion layer forming unit ACU1 according to an embodiment of the present disclosure. Referring to FIG. 5A, the first adhesion layer forming unit ACU1 may include an adhesive spraying unit ASU. The adhesive spraying unit ASU may be configured to inject (e.g., to spray or deposit) an adhesive on the first upper film UFM1. For example, the adhesive spraying unit ASU may be configured to inject the adhesive by spraying, nozzle printing, inkjet printing, or electrospinning.

In an embodiment, the first adhesion layer forming unit ACU1 may include a heating unit HEU. The heating unit HEU may be configured to heat the injected adhesive. For example, the heating unit HEU may be an infrared (IR) heater.

In an embodiment, the first adhesion layer forming unit ACU1 may include an ultraviolet (UV) irradiating unit UVU. The UV irradiating unit UVU may be configured to irradiate UV to the injected adhesive. For example, the UV irradiating unit UVU may be a UV lamp.

The first adhesion layer forming unit ACU1, according to embodiments of the present disclosure, may include an adhesive curing unit configured to cure the injected adhesive. The adhesive curing unit may include at least one selected from the heating unit HEU and the UV irradiating unit UVU.

Referring to FIG. 5B, the adhesive spraying unit ASU may include one or more injection nozzles NOZ disposed along a second direction D2 (e.g., a width direction of the first upper film UFM1). Thus, an adhesive may be uniformly injected on an overall area of the first active material layer ETL1.

In an embodiment, the first adhesion layer forming unit ACU1 may be positioned adjacent to the first pressurizing unit PRU1, which will be discussed below. For example, the first adhesion layer forming unit ACU1 may be positioned in front of the first pressurizing unit PRU1.

Referring back to FIG. 4, the first guide roller GUR1 may adjust a travel path of the first upper film UFM1 and, thus, may switch top and bottom surfaces of the first upper film UFM1. In an embodiment, the first guide roller GUR1 may switch the top and bottom surfaces of the first upper film UFM1 to allow the first active material layer ETL1 to reside on a bottom surface of the release film RFM. Thus, on the first pressurizing unit PRU1, which will be discussed below, an adhesion layer on a bottom surface of the first active material layer ETL1 may face the top surface of the electrode substrate ELS.

The first pressurizing unit PRU1 may be configured to pressurize a target object. In an embodiment, the first pressurizing unit PRU1 may include a pressurizing roller. In an embodiment, the first pressurizing unit PRU1 may roll the electrode substrate ELS and the first upper film UFM1 on the electrode substrate ELS. The pressurizing roller may roll the electrode substrate ELS and the first upper film UFM1 on the electrode substrate ELS. Thus, the first active material layer ETL1 may be transferred from the release film RFM onto the electrode substrate ELS. For example, the first active material layer ETL1 may be separated from the release film RFM, and the release film RFM may remain on the first upper film UFM1.

The first upper recovery roll URR1 may be configured to rewind the first upper film UFM1. The first upper film UFM1 that is rewound may not include the first active material layer ETL1. For example, the first upper recovery roll URR1 may be configured to recover the release film RFM after it is separated from the first active material layer ETL1.

The second upper supply roll UUR2 may be configured to unwind a second upper film UFM2. The second upper film UFM2 may include a release film RFM and a second active material layer ETL2 on the release film RFM.

The second adhesion layer forming unit ACU2 may be configured to coat an adhesive on the second active material layer ETL2 on the second upper film UFM2. Thus, an adhesion layer may be formed on the second active material layer ETL2. The second adhesion layer forming unit ACU2 may include components the same as those of the first adhesion layer forming unit ACU1 discussed above with reference to FIGS. 5A and 5B. For example, the second adhesion layer forming unit ACU2 may include an adhesive spraying unit ASU. In addition, the second adhesion layer forming unit ACU2 may include an adhesive curing unit configured to cure the injected adhesive. The adhesive curing unit may include at least one selected from the heating unit HEU and the UV irradiating unit UVU.

In an embodiment, the second adhesion layer forming unit ACU2 may be positioned adjacent to the second pressurizing unit PRU2, which will be discussed below. For example, the second adhesion layer forming unit ACU2 may be positioned in front of the second pressurizing unit PRU2.

The second guide roller GUR2 may adjust a travel path of the second upper film UFM2 and, thus, may switch top and bottom surfaces of the second upper film UFM2. In an embodiment, the second guide roller GUR2 may switch the top and bottom surfaces of the second upper film UFM2 to allow the second active material layer ETL2 to reside on a bottom surface of the release film RFM. Thus, on the second pressurizing unit PRU2 which will be discussed below, an adhesion layer on a bottom surface of the second active material layer ETL2 may face the first active material layer ETL1 on the electrode substrate ELS.

The second pressurizing unit PRU2 may be configured to pressurize a target object. In an embodiment, the second pressurizing unit PRU2 may include a pressurizing roller. In an embodiment, the second pressurizing unit PRU2 may roll the electrode substrate ELS, the first active material layer ETL1 on the electrode substrate ELS, and the second upper film UFM2 on the first active material layer ETL1. Thus, the second active material layer ETL2 may be transferred from the release film RFM onto the first active material layer ETL1. The release film RFM may remain on the second upper film UFM2.

The second upper recovery roll URR2 may be configured to rewind the second upper film UFM2. The second upper film UFM2 that is rewound may not include the second active material layer ETL2. For example, the second upper recovery roll URR2 may be configured to recover the release film RFM separated from the second active material layer ETL2.

The third upper supply roll UUR3 may be configured to unwind a third upper film UFM3. The third upper film UFM3 may include a release film RFM and a third active material layer ETL3 on the release film RFM.

The third adhesion layer forming unit ACU3 may be configured to coat an adhesive on the third active material layer ETL3 of the third upper film UFM3. Thus, an adhesion layer may be formed on the third active material layer ETL3.

The third adhesion layer forming unit ACU3 may include components the same as those of the first adhesion layer forming unit ACU1 discussed above with reference to FIGS. 5A and 5B. For example, the third adhesion layer forming unit ACU3 may include an adhesive spraying unit ASU. In addition, the third adhesion layer forming unit ACU3 may include an adhesive curing unit configured to cure the injected adhesive. The adhesive curing unit may include at least one selected from the heating unit HEU and the UV irradiating unit UVU.

In an embodiment, the third adhesion layer forming unit ACU3 may be positioned adjacent to the third pressurizing unit PRU3, which will be discussed below. For example, the third adhesion layer forming unit ACU3 may be positioned in front of the third pressurizing unit PRU3.

The third guide roller GUR3 may adjust a travel path of the third upper film UFM3 and, thus, may switch top and bottom surfaces of the third upper film UFM3. In an embodiment, the third guide roller GUR3 may switch the top and bottom surfaces of the third upper film UFM3 to allow the third active material layer ETL3 to reside on a bottom surface of the release film RFM. Thus, on the third pressurizing unit PRU3, which will be discussed below, an adhesion layer on a bottom surface of the third active material layer ETL3 may face the second active material layer ETL2.

The third pressurizing unit PRU3 may be configured to pressurize a target object. In an embodiment, the third pressurizing unit PRU3 may include a pressurizing roller. In an embodiment, the third pressurizing unit PRU3 may roll the electrode substrate ELS, the first active material layer ETL1 on the electrode substrate ELS, the second active material layer ETL2 on the first active material layer ETL1, and the third upper film UFM3 on the second active material layer ETL2. Thus, the third active material layer ETL3 may be transferred from the release film RFM onto the second active material layer ETL2. The release film RFM may remain on the third upper film UFM3.

The third upper recovery roll URR3 may be configured to rewind the third upper film UFM3. The third upper film UFM3 that is rewound may not include the third active material layer ETL3. For example, the third upper recovery roll URR3 may be configured to recover the release film RFM separated from the third active material layer ETL3.

Referring again to FIG. 4, the electrode recovery roll ERR may rewind an electrode manufactured through the first to third pressurizing units PRU1 to PRU3 discussed above.

In a multilayer electrode manufacturing apparatus according to some embodiments of the present disclosure, fully dried active material layers may be transferred to uniformly form an active material layer. Moreover, the active material coated on a release film may be positioned to allow its bottom surface (e.g., a surface in contact with the release film) to reside on a top surface of an electrode, thereby preventing a bonding force reduction due to a binder migration.

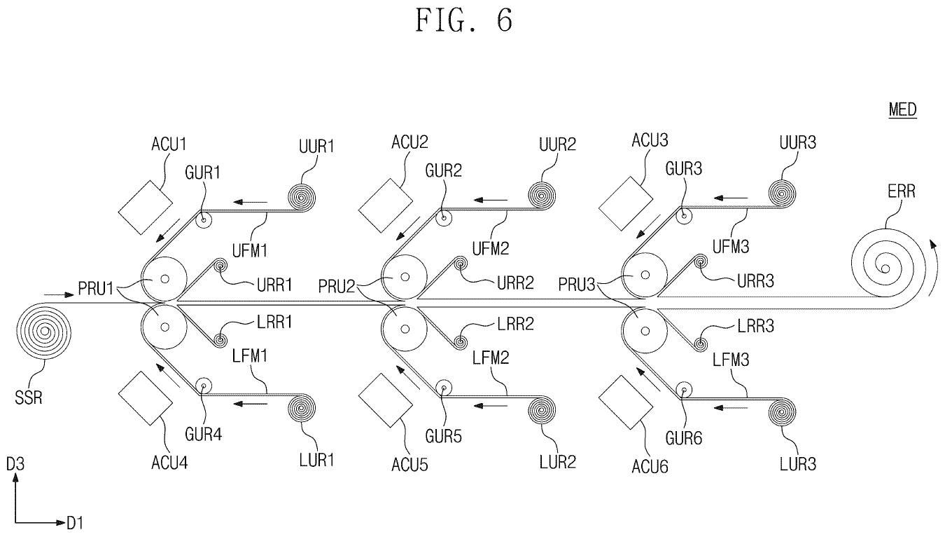

Referring to FIG. 6, the multilayer electrode manufacturing apparatus MED, according to another embodiment of the present disclosure, may further include a first lower supply roll LUR1, a fourth adhesion layer forming unit ACU4, a first lower recovery roll LRR1, a second lower supply roll LUR2, a fifth adhesion layer forming unit ACU5, a second lower recovery roll LRR2, a third lower supply roll LUR3, a sixth adhesion layer forming unit ACU6, a third lower recovery roll LRR3, and fourth, fifth, and sixth guide rollers GUR4, GUR5, and GUR6.

The first lower supply roll LUR1 may be configured to unwind a first lower film LFM1. The first lower film LFM1 may include a release film RFM and a fourth active material layer ETL4 on the release film RFM.

The fourth adhesion layer forming unit ACU4 may be configured to coat an adhesive on the fourth active material layer ETL4 of the first lower film LFM1. Thus, an adhesion layer may be formed on the fourth active material layer ETL4.

The fourth adhesion layer forming unit ACU4 may include components the same as those of the first adhesion layer forming unit ACU1 discussed above with reference to FIGS. 5A and 5B. For example, the fourth adhesion layer forming unit ACU4 may include an adhesive spraying unit ASU. In addition, the fourth adhesion layer forming unit ACU4 may include an adhesive curing unit configured to cure the injected adhesive. The adhesive curing unit may include at least one selected from the heating unit HEU and the UV irradiating unit UVU.

In an embodiment, the fourth adhesion layer forming unit ACU4 may be positioned adjacent to the first pressurizing unit PRU1 discussed above. For example, the fourth adhesion layer forming unit ACU4 may be positioned in front of the first pressurizing unit PRU1.

The fourth guide roller GUR4 may adjust a travel path of the first lower film LFM1 and, thus, may switch top and bottom surfaces of the first lower film LFM1. In an embodiment, the fourth guide roller GUR4 may switch the top and bottom surfaces of the first lower film LFM1 to allow the fourth active material layer ETL4 to reside on a top surface of the release film RFM. Thus, on the first pressurizing unit PRU1 discussed above, an adhesion layer on a top surface of the fourth active material layer ETL4 may face the bottom surface of the electrode substrate ELS.

In an embodiment, the first pressurizing unit PRU1 may roll the electrode substrate ELS, the first upper film UFM1 on the top surface of the electrode substrate ELS, and the first lower film LFM1 on the bottom surface of the electrode substrate ELS. Thus, the first active material layer ETL1 may be transferred onto the top surface of the electrode substrate ELS, and the fourth active material layer ETL4 may be transferred onto the bottom surface of the electrode substrate ELS.

The first lower recovery roll LRR1 may be configured to rewind the first lower film LFM1. The first lower film LFM1 that is rewound may not include the fourth active material layer ETL4. For example, the first lower recovery roll LRR1 may be configured to recover the release film RFM separated from the fourth active material layer ETL4.

The second lower supply roll LUR2 may be configured to unwind a second lower film LFM2. The second lower film LFM2 may include a release film RFM and a fifth active material layer ETL5 on the release film RFM.

The fifth adhesion layer forming unit ACU5 may be configured to coat an adhesive on the fifth active material layer ETL5 of the second lower film LFM2. Thus, an adhesion layer may be formed on the fifth active material layer ETL5.

The fifth adhesion layer forming unit ACU5 may include components the same as those of the first adhesion layer forming unit ACU1 discussed above with reference to FIGS. 5A and 5B. For example, the fifth adhesion layer forming unit ACU5 may include an adhesive spraying unit ASU. In addition, the fifth adhesion layer forming unit ACU5 may include an adhesive curing unit configured to cure the injected adhesive. The adhesive curing unit may include at least one selected from the heating unit HEU and the UV irradiating unit UVU.

In an embodiment, the fifth adhesion layer forming unit ACU5 may be positioned adjacent to the second pressurizing unit PRU2 discussed above. For example, the fifth adhesion layer forming unit ACU5 may be positioned in front of the second pressurizing unit PRU2.

The fifth guide roller GUR5 may adjust a travel path of the second lower film LFM2 and, thus, may switch top and bottom surfaces of the second lower film LFM2. In an embodiment, the fifth guide roller GUR5 may switch the top and bottom surfaces of the second lower film LFM2 to allow the fifth active material layer ETL5 to reside on a top surface of the release film RFM. Thus, on the second pressurizing unit PRU2 discussed above, an adhesion layer on a top surface of the fifth active material layer ETL5 may face the fourth active material layer ETL4 on the bottom surface of the electrode substrate ELS.

In an embodiment, the second pressurizing unit PRU2 may roll the electrode substrate ELS, the first active material layer ETL1 on the top surface of the electrode substrate ELS, the second upper film UFM2 on a top surface of the first active material layer ETL1, the fourth active material layer ETL4 on the bottom surface of the electrode substrate ELS, and the second lower film LFM2 on a bottom surface of the fourth active material layer ETL4. Thus, the second active material layer ETL2 may be transferred onto the top surface of the first active material layer ETL1, and the fifth active material layer ETL5 may be transferred onto the bottom surface of the fourth active material layer ETL4.

The second lower recovery roll LRR2 may be configured to rewind the second lower film LFM2. The second lower film LFM2 that is rewound may not include the fifth active material layer ETL5. For example, the second lower recovery roll LRR2 may be configured to recover the release film RFM separated from the fifth active material layer ETL5.

The third lower supply roll LUR3 may be configured to unwind a third lower film LFM3. The third lower film LFM3 may include a release film RFM and a sixth active material layer ETL6 on the release film RFM.

The sixth adhesion layer forming unit ACU6 may be configured to coat an adhesive on the sixth active material layer ETL6 of the third lower film LFM3. Thus, an adhesion layer may be formed on the sixth active material layer ETL6.

The sixth adhesion layer forming unit ACU6 may include components the same as those of the first adhesion layer forming unit ACU1 discussed above with reference to FIGS. 5A and 5B. For example, the sixth adhesion layer forming unit ACU6 may include an adhesive spraying unit ASU. In addition, the sixth adhesion layer forming unit ACU6 may include an adhesive curing unit configured to cure the injected adhesive. The adhesive curing unit may include at least one selected from the heating unit HEU and the UV irradiating unit UVU.

In an embodiment, the sixth adhesion layer forming unit ACU6 may be positioned adjacent to the third pressurizing unit PRU3 discussed above. For example, the sixth adhesion layer forming unit ACU6 may be positioned in front of the second pressurizing unit PRU2.

The sixth guide roller GUR6 may adjust a travel path of the third lower film LFM3 and, thus, may switch top and bottom surfaces of the third lower film LFM3. In an embodiment, the sixth guide roller GUR6 may switch the top and bottom surfaces of the third lower film LFM3 to allow the sixth active material layer ETL6 to reside on a top surface of the release film RFM. Thus, on the third pressurizing unit PRU3 discussed above, an adhesion layer on a top surface of the sixth active material layer ETL6 may face the fifth active material layer ETL5.

In an embodiment, the third pressurizing unit PRU3 may roll the electrode substrate ELS, the first active material layer ETL1 on the top surface of the electrode substrate ELS, the second active material layer ETL2 on a top surface of the first active material layer ETL1, the third upper film UFM3 on a top surface of the second active material layer ETL2, the fourth active material layer ETL4 on the bottom surface of the electrode substrate ELS, the fifth active material layer ETL5 on a bottom surface of the fourth active material layer ETL4, and the third lower film LFM3 on a bottom surface of the fifth active material layer ETL5. Thus, the third active material layer ETL3 may be transferred onto the top surface of the second active material layer ETL2, and the sixth active material layer ETL6 may be transferred onto the bottom surface of the fifth active material layer ETL5.

The third lower recovery roll LRR3 may be configured to rewind the third lower film LFM3. The third lower film LFM3 that is rewound may not include the sixth active material layer ETL6. For example, the third lower recovery roll LRR3 may be configured to recover the release film RFM separated from the sixth active material layer ETL6.

The electrode recovery roll ERR may rewind an electrode manufactured through the first to third pressurizing units PRU1 to PRU3 discussed above.

In a multilayer electrode manufacturing apparatus according to some embodiments of the present disclosure, active materials may be concurrently (or simultaneously) transferred onto top and bottom surfaces of an electrode substrate, and thus, active material layers may be uniformly formed on the top and bottom surfaces of the electrode substrate.

### Multilayer Electrode Manufacturing Method

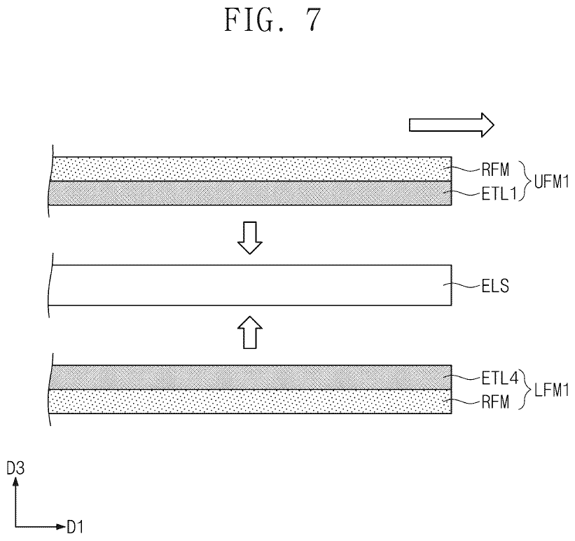

FIGS. 7 to 12 are cross-sectional views of steps of a multilayer electrode manufacturing method according to an embodiment of the present disclosure. FIGS. 7 to 12 describe steps of a multilayer electrode manufacturing method using the multilayer electrode manufacturing apparatus discussed above with reference to FIGS. 4 to 6.

Referring to FIGS. 6 and 7, the first upper film UFM1 may be provided on a top surface of the electrode substrate ELS that travels, and the first lower film LFM1 may be provided on a bottom surface of the electrode substrate ELS.

For example, the electrode substrate may be unwounded from the electrode substrate supply roll SSR. The electrode substrate ELS may travel in a first direction D1. The first upper film UFM1 may be unwound from the first upper supply roll UUR1. The first lower film LFM1 may be unwound from the first lower supply roll LUR1.

The first upper film UFM1 may include a release film RFM and a first active material layer ETL1 on the release film RFM. The first lower film LFM1 may include a release film RFM and a fourth active material layer ETL4 on the release film RFM.

The first guide roller GUR1 may adjust a travel path of the first upper film UFM1. When the first upper film UFM1 passes through the first pressurizing unit PRU1, which will be discussed below, top and bottom surfaces of the first upper film UFM1 may be switched to allow the first active material layer ETL1 to reside on a bottom surface of the release film RFM.

The fourth guide roller GUR4 may adjust a travel path of the first lower film LFM1. When the first lower film LFM1 passes through the first pressurizing unit PRU1 which will be discussed below, top and bottom surfaces of the first lower film LFM1 may be switched to allow the fourth active material layer ETL4 to reside on a top surface of the release film RFM.

An adhesive may be injected to each of the first upper film UFM1 and the first lower film LFM1, thereby forming an adhesion layer. The adhesive may be injected by the first and fourth adhesion layer forming units ACU1 and ACU4 discussed with reference to FIGS. 4 to 6, but the present disclosure is not limited thereto. For example, the adhesive may be injected by spraying, nozzle printing, inkjet printing, or electrospinning. Thus, an adhesion layer may be formed on the first active material layer ETL1 and the fourth active material layer ETL4.

In an embodiment, an amount of adhesive injected per unit area of the first upper film UFM1 may be in a range from about 0.1 g/m2 to about 1.0 g/m2.

The adhesive may include at least one selected from UV curable resin compositions, thermosetting resin, and thermoplastic resin.

The UV curable resin composition may include a UV curable resin, a solvent, and a photopolymerization initiator.

In an embodiment, the photopolymerization initiator may be included in an amount in a range of about 0.01 wt % to about 10 wt % relative to the total weight of the UV curable resin composition. For example, the photopolymerization initiator may be included in an amount in a range of about 0.01 wt % to about 5 wt % or about 0.5 wt % to about 3 wt %.

In an embodiment, the UV curable resin may include urethane acrylate, unsaturated polyester, epoxy acrylate, octane, vinyl ether, polyester acrylate, silicone acrylate, cycloaliphatic epoxy resin, glycidyl ether epoxy resin, or any combination thereof.

In an embodiment, the solvent may include water or an organic solvent. For example, the organic solvent may include 1-methyl-2-pyrrolidinone (NMP) or acetone.

In an embodiment, the photopolymerization initiator may include Alkyl ketone compounds, aryl phosphine oxide compounds, titanocene compounds, oxime ester compounds, benzoin compounds, acetophenone compounds, benzophenone compounds, thioxanthone compounds, α-acyloxy oxime ester compounds, phenylglyoxylic ester compounds, benzyl compounds, azo compounds, diphenyl sulfide compounds, organic dye compounds, iron-phthalocyanine compounds, benzoin ether compounds, anthraquinone compounds, diazonium salts, iodonium salts, sulfonium salts, metallocene compounds, or any combination thereof.

In an embodiment, the thermosetting resin may include epoxy resin, phenolic resin, melamine resin, urea resin, unsaturated polyester resin, alkyd resin, silicone resin, polyurethane resin, polyimide resin, or any combination thereof.

In an embodiment, the thermoplastic resin may include polytetrafluoroethylene, polyethylene, polypropylene, polystyrene, polyvinyl chloride, polyvinylidene chloride, fluororesin, acrylic resin, polyvinyl acetate resin, polyamide resin, polycarbonate, acetal resin, polyphenylene oxide, polyester, polysulfone, or any combination thereof.

The adhesion layer formed on the first and second active material layers ETL1 and ETL4 may increase a bonding force with the electrode substrate ELS.

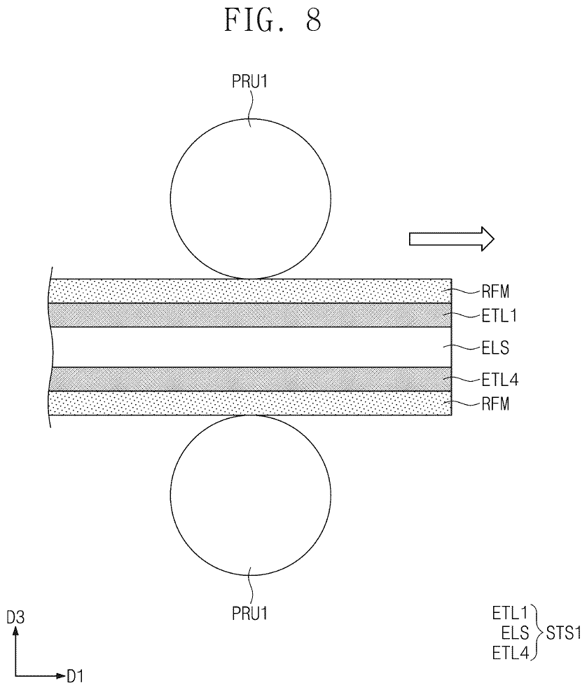

Referring to FIGS. 6 and 8, the electrode substrate ELS, the first upper film UFM1 on a top surface of the electrode substrate ELS, and the first lower film LFM1 on a bottom surface of the electrode substrate ELS may be rolled together. Thus, the first active material layer ETL1 of the first upper film UFM1 may be transferred onto the top surface of the electrode substrate ELS, and the fourth active material layer ETL4 of the first lower film LFM1 may be transferred onto the bottom surface of the electrode substrate ELS. As a result, a first stack STS1 may be formed. The first stack STS1 may include the electrode substrate ELS, the first active material layer ETL1 on the top surface of the electrode substrate ELS, and the fourth active material layer ETL4 on the bottom surface of the electrode substrate ELS.

The first upper film UFM1 may be rewound on the first upper recovery roll URR1. The first upper film UFM1 may not include the first active material layer ETL1. For example, the first upper film UFM1 that is rewound may be the release film RFM. The first lower film LFM1 may be rewound on the first lower recovery roll LRR1. The first lower film LFM1 that is rewound may not include the fourth active material layer ETL4. For example, the first lower film LFM1 being rewound may be the release film RFM.

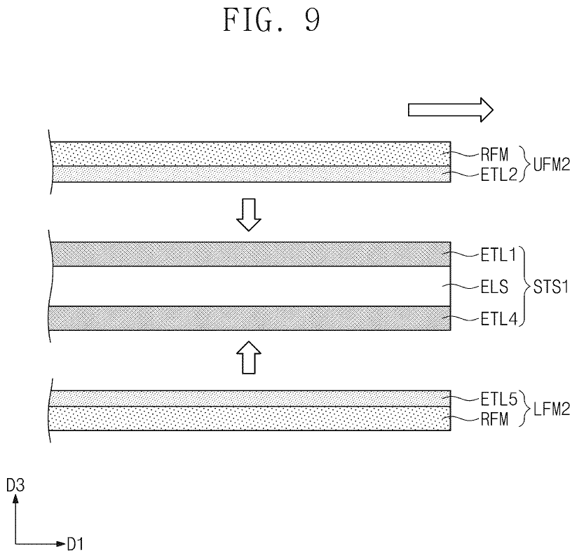

Referring to FIGS. 6 and 9, the second upper film UFM2 may be provided on a top surface of the first stack STS1, and the second lower film LFM2 may be provided on a bottom surface of the first stack STS1.

For example, the first stack STS1 may travel in the first direction D1. The second upper film UFM2 may be unwound from the second upper supply roll UUR2. The second lower film LFM2 may be unwound from the second lower supply roll LUR2.

The second upper film UFM2 may include a release film RFM and a second active material layer ETL2 on the release film RFM. The second lower film LFM2 may include a release film RFM and a fifth active material layer ETL5 on the release film RFM.

The second guide roller GUR2 may adjust a travel path of the second upper film UFM2. When the second upper film UFM2 passes through the second pressurizing unit PRU2, which will be discussed below, top and bottom surfaces of the second upper film UFM2 may be switched to allow the second active material layer ETL2 to reside on a bottom surface of the release film RFM.

The fifth guide roller GUR5 may adjust a travel path of the second lower film LFM2. When the second lower film LFM2 passes through the second pressurizing unit PRU2, which will be discussed below, top and bottom surfaces of the second lower film LFM2 may be switched to allow the fifth active material layer ETL5 to reside on a top surface of the release film RFM.

An adhesive may be injected to each of the second upper film UFM2 and the second lower film LFM2, thereby forming an adhesion layer. The adhesion layer may be formed by using the method for forming the aforementioned adhesion layer on the first upper film UFM1 and the first lower film LFM1.

The adhesion layer formed on the second and fifth active material layers ETL2 and ETL5 may increase a bonding force with the first and fourth active material layers ETL1 and ETL4.

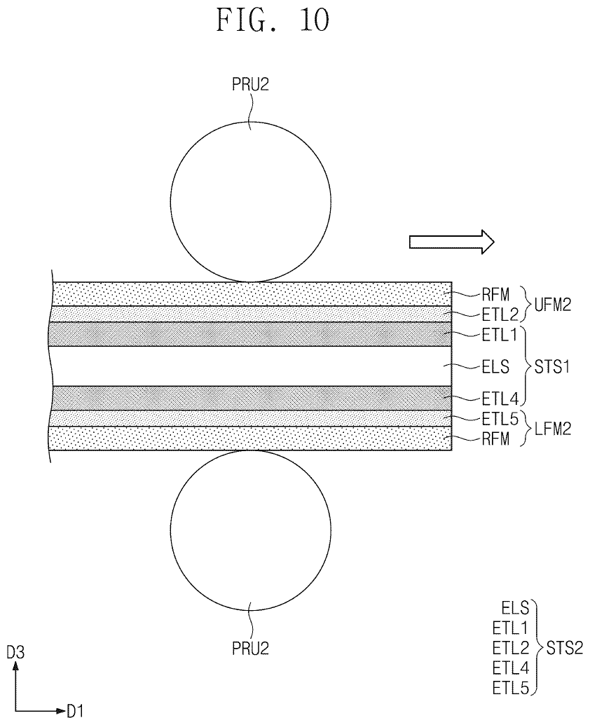

Referring to FIGS. 6 and 10, the first stack STS1, the second upper film UFM2 on a top surface of the first stack STS1, and the second lower film LFM2 on a bottom surface of the first stack STS1 may be rolled together. Thus, the second active material layer ETL2 of the second upper film UFM2 may be transferred onto the top surface of the first stack STS1, and the fifth active material layer ETL5 of the second lower film LFM2 may be transferred onto the bottom surface of the first stack STS1. As a result, a second stack STS2 may be formed. The second stack STS2 may include the first stack STS1, the second active material layer ETL2 on the top surface of the first stack STS1, and the fifth active material layer ETL5 on the bottom surface of the first stack STS1.

The second upper film UFM2 may be rewound on the second upper recovery roll URR2. The second upper film UFM2 may not include the second active material layer ETL2. For example, the second upper film UFM2 that is rewound may be the release film RFM. The second lower film LFM2 may be rewound on the second lower recovery roll LRR2. The second lower film LFM2 that is rewound may not include the fifth active material layer ETL5. For example, the second lower film LFM2 being rewound may be the release film RFM.

In an embodiment, the second stack STS2 may be rewound on the electrode recovery roll ERR.

In an embodiment, as discussed below, a third active material layer ETL3 and a sixth active material layer ETL6 may be further stacked on the second stack STS2.

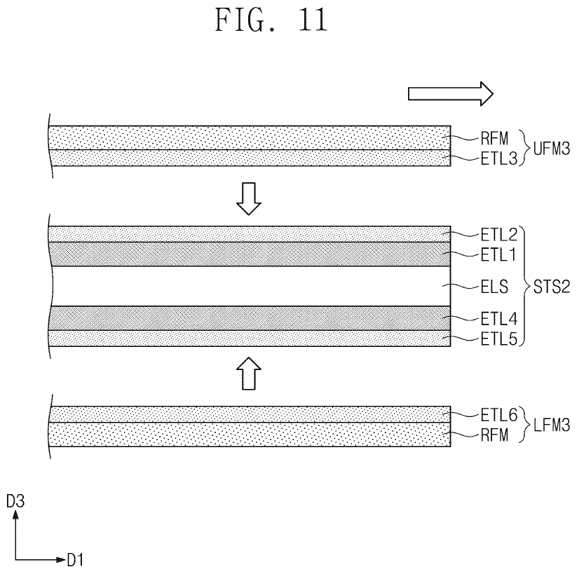

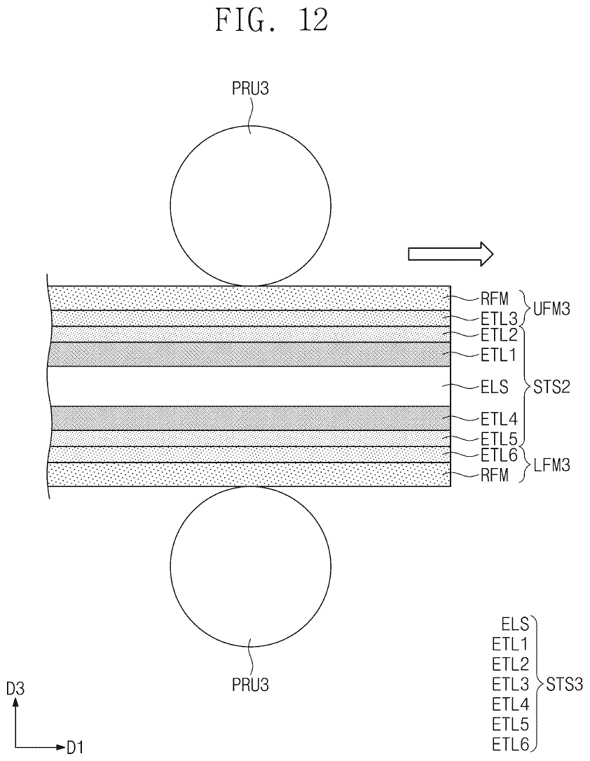

Referring to FIGS. 6 and 11, the third upper film UFM3 may be provided on a top surface of the second stack STS2, and the third lower film LFM3 may be provided on a bottom surface of the second stack STS2.

For example, the second stack STS2 may travel in the first direction D1. The third upper film UFM3 may be unwound from the third upper supply roll UUR3. The third lower film LFM3 may be unwound from the third lower supply roll LUR3.

The third upper film UFM3 may include a release film RFM and a third active material layer ETL3 on the release film RFM. The third lower film LFM3 may include a release film RFM and a sixth active material layer ETL6 on the release film RFM.

The third guide roller GUR3 may adjust a travel path of the third upper film UFM3. When the third upper film UFM3 passes through the third pressurizing unit PRU3, which will be discussed below, top and bottom surfaces of the third upper film UFM3 may be switched to allow the third active material layer ETL3 to reside on a bottom surface of the release film RFM.

The sixth guide roller GUR6 may adjust a travel path of the third lower film LFM3. When the third lower film LFM3 passes through the third pressurizing unit PRU3, which will be discussed below, top and bottom surfaces of the third lower film LFM3 may be switched to allow the sixth active material layer ETL6 to reside on a top surface of the release film RFM.

An adhesive may be injected to each of the third upper film UFM3 and the third lower film LFM3, thereby forming an adhesion layer. The adhesion layer may be formed by using the method for forming the aforementioned adhesion layer on the first upper film UFM1 and the first lower film LFM1.

The adhesion layer formed on the third and sixth active material layers ETL3 and ETL5 may increase a bonding force with the second and fifth active material layers ETL2 and ETL5.

Referring to FIGS. 6 and 12, the second stack STS2, the third upper film UFM3 on a top surface of the second stack STS2, and the third lower film LFM3 on a bottom surface of the second stack STS2 may be rolled together. Thus, the third active material layer ETL3 of the third upper film UFM3 may be transferred onto the top surface of the second stack STS2, and the sixth active material layer ETL6 of the third lower film LFM3 may be transferred onto the bottom surface of the second stack STS2. As a result, a third stack STS3 may be formed. The third stack STS3 may include the second stack STS2, the third active material layer ETL3 on the top surface of the second stack STS2, and the sixth active material layer ETL6 on the bottom surface of the second stack STS2.

The third upper film UFM3 may be rewound on the third upper recovery roll URR3. The third upper film UFM3 may not include the third active material layer ETL3. For example, the third upper film UFM3 that is rewound may be the release film RFM. The third lower film LFM3 may be rewound on the third lower recovery roll LRR3. The third lower film LFM3 that is rewound may not include the sixth active material layer ETL6. For example, the third lower film LFM3 being rewound may be the release film RFM.

In an embodiment, the third stack STS3 may be rewound on the electrode recovery roll ERR.

The multilayer electrode manufacturing method, according to some embodiments of the present disclosure, may further include preparing the first to third upper films UFM1 to UFM3 and the first to third lower films LFM1 to LFM3.

The preparation of the first upper film UFM1 may include coating a first active material layer slurry on the release film RFM and drying the first active material layer slurry. Thus, the first upper film UFM1 may be prepared in which the first active material layer ETL1 is formed on the release film RFM.

The preparation of the first upper film UFM1 may further include pre-pressurizing the first upper film UFM1. In an embodiment, the first upper film UFM1 may be pre-pressurized to allow the first active material layer ETL1 to have a density equal to or greater than about 70% and less than about 100% of a mixture density of a finally formed electrode. In an embodiment, the first upper film UFM1 may be rolled by passing through a pressurizing roller.

The second and third upper films UFM2 and UFM3 may be prepared by the same or substantially similar method as that used to prepare the first upper film UFM1, except that the release film RFM is coated respectively with second and third active material layer slurries instead of the first active material layer.

The first, second, and third lower films LFM1, LFM2, and LFM3 may be prepared by the same or substantially similar method as that used to prepare the first upper film UFM1, except that the release film RFM is coated respectively with fourth, fifth, and sixth active material layer slurries instead of the first active material layer.

The first to sixth active material layer slurries may respectively include the first to sixth binders discussed with reference to FIGS. 2 and 3. For example, the first active material layer slurry may include the first binder, and the second active material layer slurry may include the second binder.

In an embodiment, the binders included in the first to sixth active material layer slurries may have their amounts as follows:

The first binder may be included in an amount in a range of about 50 wt % to about 95 wt % relative to the total weight of the first and second binders, and the second binder may be included in an amount in a range of about 5 wt % to about 50 wt % relative to the total weight of the first and second binders.

In an embodiment, the binders included in the first to sixth active material layer slurries may have their amounts as follows:

The first binder may be included in an amount in a range of about 20 wt % to about 90 wt % relative to the total weight of the first to third binders, the second binder may be included in an amount in a range of about 5 wt % to about 40 wt % relative to the total weight of the first to third binders, and the third binder may be included in an amount in a range of about 5 wt % to about 40 wt % relative to the total weight of the first to third binders.

In a multilayer electrode manufactured by the method according to some embodiments of the present disclosure, fully dried active materials may be stacked to form a multilayer electrode, thereby forming a uniform active material layer.

In addition, when the active material layer is coated and dried on a release film, a binder migration phenomenon may cause a binder to concentrate on an upper portion of the active material layer. The active material layer may have an upper portion on which the binder is concentrated, and the upper portion of the active material layer may be used as a contact surface, which may result in an increase in bonding force.

In a multilayer electrode manufacturing apparatus according to embodiments of the present disclosure, a roll-to-roll method may be employed to manufacture a multilayer-structured electrode and each active material layer of the multilayer-structured electrode may be uniformly formed.

In a multilayer electrode manufacturing apparatus according to embodiments of the present disclosure, a substrate and a release film coated with an active material layer may be rolled to transfer the active material from the release film onto the substrate. Therefore, the active material layer may have a top surface on which a binder is concentrated, and the top surface of the active material layer may be used as an adhesive surface, which may result in an increase in bonding force between the active material layer and the electrode substrate.

In a multilayer electrode manufacturing apparatus according to embodiments of the present disclosure, an adhesive spraying unit may be included to induce an increase in bonding force between an active material and an electrode substrate.

In a multilayer electrode manufacturing apparatus and method according to embodiments of the present disclosure, a roll-to-roll process may be used to roll a substrate and a release film coated with an active material layer, and accordingly a multilayer-structured electrode may be fabricated continuously without the need of separate drying processes.

While this disclosure has been described in connection with what is presently considered to be suitable example embodiments, it is to be understood that the present disclosure is not limited to the disclosed embodiments and is intended to cover various modifications and equivalent arrangements included within the spirit and scope of the appended claims and their equivalents. Therefore, the aforementioned embodiments should be understood to be exemplarily but not limiting this disclosure in any way.

What is claimed is:

1. A multilayer electrode manufacturing apparatus comprising:
an electrode substrate supply roll configured to unwind an electrode substrate;
a first upper supply roll configured to unwind a first upper film, the first upper film comprising a first release film and a first active material layer on the first release film;
a first pressurizing unit configured to pressurize together the electrode substrate, the first active material layer, and the first release film that are sequentially stacked; and
a first upper recovery roll configured to recover the first release film by separating the first release film from the first active material layer.

2. The apparatus as claimed in claim 1, wherein the first pressurizing unit is configured to transfer the first active material layer from the first release film onto the electrode substrate.

3. The apparatus as claimed in claim 1, further comprising a first adhesion layer forming unit in front of the first pressurizing unit,
wherein the first adhesion layer forming unit is configured to coat an adhesive on the first active material layer of the first upper film.

4. The apparatus as claimed in claim 3, wherein the first adhesion layer forming unit comprises:
an adhesive spraying unit configured to spray the adhesive; and
an adhesive curing unit configured to cure the adhesive, and
wherein the adhesive curing unit comprises at least one selected from a heating unit and an ultraviolet irradiating unit.

5. The apparatus as claimed in claim 1, further comprising a first guide roller,
wherein the first guide roller is configured to adjust a travel path of the first upper film such that the first active material layer of the first upper film faces the electrode substrate.

6. The apparatus as claimed in claim 1, further comprising:
a second upper supply roll configured to unwind a second upper film, the second upper film comprising a second release film and a second active material layer on the second release film; and
a second pressurizing unit,
wherein the second pressurizing unit is configured to pressurize together the electrode substrate, the first active material layer, the second active material layer, and the second release film that are sequentially stacked.

7. The apparatus as claimed in claim 1, wherein the first active material layer comprises one of a positive electrode active material and a negative electrode active material, and
wherein the first active material layer further comprises a first binder and a first conductive material.

8. A multilayer electrode manufacturing apparatus comprising:
an electrode substrate supply roll configured to unwind an electrode substrate;
a first upper supply roll configured to unwind and provide a first upper film on a top surface of the electrode substrate, the first upper film comprising a first release film and a first active material layer on the first release film;
a first lower supply roll configured to unwind and provide a first lower film on a bottom surface of the electrode substrate, the first lower film comprising a second release film and a second active material layer on the second release film; and
a first pressurizing unit configured to pressurize together the second release film, the second active material layer, the electrode substrate, the first active material layer, and the first release film that are sequentially stacked.

9. The apparatus as claimed in claim 8, further comprising:
a first upper recovery roll configured to recover the first release film by separating the first release film from the first active material layer; and
a first lower recovery roll configured to recover the second release film by separating the second release film from the second active material layer.

10. The apparatus as claimed in claim 8, further comprising a first adhesion layer forming unit in front of the first pressurizing unit,
wherein the first adhesion layer forming unit is configured to coat an adhesive on the first active material layer of the first upper film.

11. The apparatus as claimed in claim 10, wherein the first adhesion layer forming unit comprises:
an adhesive spraying unit configured to spray the adhesive; and
an adhesive curing unit configured to cure the adhesive, and
wherein the adhesive curing unit comprises at least one selected from a heating unit and an ultraviolet irradiating unit.

12. The apparatus as claimed in claim 8, further comprising a first guide roller,
wherein the first guide roller is configured to adjust a travel path of the first upper film such that the first active material layer of the first upper film faces the electrode substrate.

13. The apparatus as claimed in claim 9, further comprising:
a second upper supply roll configured to unwind and provide a second upper film on a top surface of the first active material layer, the second upper film comprising a third release film and a third active material layer on the third release film;
a second lower supply roll configured to unwind and provide a second lower film on a bottom surface of the second active material layer, the second lower film comprising a fourth release film and a fourth active material layer on the fourth release film; and
a second pressurizing unit configured to pressurize together the fourth release film, the fourth active material layer, the second active material layer, the electrode substrate, the first active material layer, and the third active material layer that are sequentially stacked.

14. A multilayer electrode manufacturing method, the method comprising:
providing a first upper film on a top surface of an electrode substrate as the electrode substrate travels in a first direction, the first upper film comprising a first release film and a first active material layer on the first release film;
performing a first pressurization process to pressurize together the electrode substrate, the first active material layer, and the first release film that are sequentially stacked;
selectively removing the first release film to form a first stack comprising the electrode substrate and the first active material layer;
providing a second upper film on a top surface of the first stack, the second upper film comprising a second release film and a second active material layer on the second release film; and
performing a second pressurization process to pressurize together the first stack, the second active material layer, and the second release film that are sequentially stacked.

15. The method as claimed in claim 14, further comprising, before the performing of the first pressurization process, coating an adhesive on the first active material layer.

16. The method as claimed in claim 15, wherein the adhesive comprises at least one selected from an ultraviolet curable resin composition, a thermosetting resin, and a thermoplastic resin.

17. The method as claimed in claim 16, wherein the ultraviolet curable resin composition comprise an ultraviolet curable resin, a solvent, and a photopolymerization initiator.

18. The method as claimed in claim 14, wherein, relative to a total weight of binders of the first and second active material layers, the binder of the first active material layer is present in an amount in a range of 50 wt % to 95 wt % and the binder of the second active material layer is present in an amount in a range of 5 wt % to 50 wt %.

19. The method as claimed in claim 14, further comprising:
selectively removing the second release film to form a second stack comprising the electrode substrate, the first active material layer, and the second active material layer;
providing a third upper film on a top surface of the second stack, the third upper film comprising a third release film and a third active material layer on the third release film; and
performing a third pressurization process to pressurize together the second stack, the third active material layer, and the third release film that are sequentially stacked.

20. The method as claimed in claim 19, wherein, relative to a total weight of binders of the first, second, and third active material layers, the binder of the first active material layer is present in an amount in a range of 20 wt % to 90 wt %, the binder of the second active material layer is present in an amount in a range of 5 wt % to 40 wt %, and the binder of the third active material layer is present in an amount in a range of 5 wt % to 40 wt %.
